(19) United States
(12) Patent Application Publication
(10) Pub. No.: US 2010/0032957 A1
(43) Pub. Date: Feb. 11, 2010

(54) Energy Generation System for Reduced Visual Pollution and Cost

(76) Inventor: Timothy Joseph Stephany, Williamson, NY (US)

Correspondence Address: Timothy Joseph Stephany, 3369 Lake Road, Williamson, NY, 14589-9238, US

(21) Appl. No.: 12/189,777

(22) Filed: Aug. 11, 2008

(51) Int. Cl. F03D 1/02

(52) U.S. Cl. 290/55

(57) ABSTRACT

This invention is an improvement on systems that use wind to generate electrical power. It reduces visual pollution and cost, and increases the system efficiency over the prior art of wind powered electrical generators. The proposed system uses a plurality of wind-driven energy harnessers or propellers connected to one or a very few electrical generators, replacing the multiplicity of individual wind-power propellers each connected separately to its own generator. It permits better flexibility in design to reduce or unwanted effects, such as visual pollution which is a major problem with present state of the art wind generating plants. The invention also incorporates a storage system to produce energy during period when the harnessers are not capturing sufficient energy from the wind to provide the electrical power needed. The electrical power generated can then be connected to a power grid or other energy network to provide useful energy.

### BACKGROUND OF THE INVENTION

Using the wind to drive electrical alternators to provide power to our homes and industry represents a fuel-less method resulting in no pollution. The main drawback is that the wind is not steady and backup systems to provide electrical power are needed during periods of insufficient wind velocity. as a result wind a systems can only be depended upon to provide about 10% to 15% of the total power since it is uneconomical to exceed this level by constructing backup systems that are seldom used.

Present wind systems being used suffer from an additional problem: the construction of large towers with propellers several hundred feet long is a distraction and irritation to scenery and many people object to the hypnotic effect of a large number of these systems located near each other and in the areas of populated land. They are a visual nuisance that may be distracting and are prone to fragmentation during high-velocity winds, creating large projectiles and various potential dangers. A system permitting greater flexibility of design is thus required.

Several systems have been patented to overcome the first problem. In U.S. Pat. No. 6,023,105, Feb. 8, 2000, it was proposed that water be pumped by the wind blades, then stored at a high level and later released during periods of low wind to supplement power generation. In U.S. Pat. No. 6,559,552, May 6 2003, it is proposed that a combination of wind, solar, water wheel, and rain be used. Such a system could not deliver sufficient power for a city and is restricted to individual homes, and cannot supply any where near the total power required by a society. In U.S. Pat. No. 6,718,761, Apr. 13, 2004, the wind is used to compress air, which is stored and then used to turn turbines connected to electrical alternators for power generation. This efficiency of the system is low and expense is high and is not considered adequate for most cities. In U.S. Pat. No. 6,766,643, Jul. 27, 2004, a system that combines wind and waves is used but also is not adequate for large scale power generation.

### SUMMARY OF THE INVENTION

The object of this invention to be a system in which small and inconspicuous energy generation units are used that can be distributed throughout a city and surrounding country with no perceived visual pollution. Two fundamental systems are proposed for the conveyance of energy from the individual units designed to be unobtrusive that are connected through fluid, pipe, shaft, or conduit to an energy generator or alternator, that provides useful energy that can be conveyed through a distribution system or into an energy storage or collection system, such as a site for potential energy storage or a form of battery. The importance of the invention as it is configured is to provide flexibility in the design of the energy harnessing units to permit them to be smaller or less noticeable or more inexpensive.

### BRIEF DESCRIPTION OF THE DRAWINGS

References are made to the preferred embodiments of the invention within these figures in order to provide a better understanding of the manifestations of the invention.

FIG. 1. is a schematic illustration of one configuration of the fluid energy-conveyance system of the present invention.

FIG. 2. is a schematic illustration of another configuration of the fluid energy-conveyance system of the present invention.

FIG. 3. is a schematic illustration of one configuration of a mechanical energy-conveyance system of the present invention.

FIG. 4. is a schematic illustration of one configuration of another mechanical energy-conveyance system of the present invention.

### DESCRIPTION OF THE INVENTION

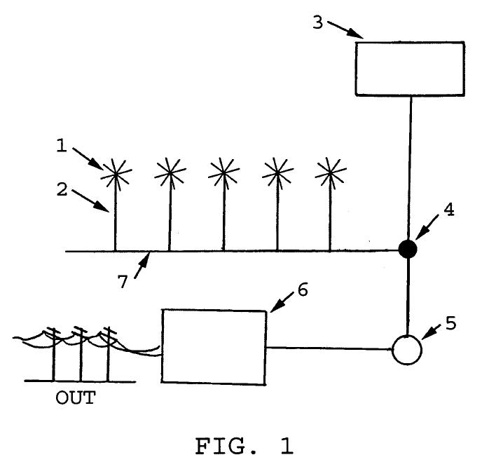

Now in reference to FIG. 1 which shows a configuration of the system with the transmission of energy as captured through an array of propellers 1 that are shown upon shafts 2 that pump fluid through a conduit transmission system 7 that passes through a pump station 4 that conveys some proportion to a storage tank 3 and some proportion to turn a turbine 5, with the turbine connected to an electrical generator 6. The invention incorporates a storage system so the system can store power during periods when excess energy is produced and then used when the harnessers are not capturing sufficient energy. The storage system can be an elevated storage tank (an ideal fluid would be water). At the times that energy is being harnessed which exceed the needed amount, the excess fluid can be directed to the storage tank. When the capturing system is not producing sufficient power to meet the amount needed, the fluid runs down to produces a power output by turning the turbine as in a conventional hydroelectric station. FIG. 1 can also be used in the same manner using electrical transmission, where there are electrical conduit lines 7 and storage using electrical storage 3.

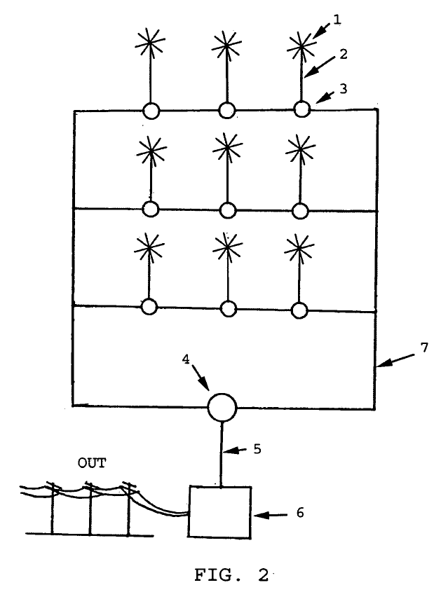

In reference to the invention configuration in FIG. 2, the individual pumps can be in a serial arrangement to increase pressure. These pumps can also be arranged in parallel to increase the quantity of fluid. FIG. 2 shows what consists of a surface or surfaces with energy harnessers in the form of many wind-driven propellers 1 located upon it. The multiplicity of individual harnessers is each separately linked through a shaft 2 to convey the energy to pumps 3 to move a fluid (ex. water). This fluid, in turn, is piped through a system 7 to a single or few turbines 4, through a shaft or path 5, that drives an electrical generator or alternator 6 to produces useful energy. The harnessers would therefore convey and conduct wind energy, which provides electric energy through the use of a fluid turbine connected to an electrical generator. Each of the harnessers can then be designed to produce the most efficient return of energy and the least visual pollution or cost. The electrical generator can then be connected to an energy providing system, such as a power grid.

The harnessers would be able to convey their captured energy by means of a mechanical shaft to a pump near the harnesser, or with a mechanical gear system, to a pump at the base of a supporting tower. The system then saves having to put the weight of a pump in the tower as well as the weight of an electrical generator as in the prior art. These pumps would both supply power to turn a turbine, which turns an electric generator with any excess amount of water going to an elevated storage tank for use when needed in the future. The number of wind harnessers would be placed to permit the greatest power return per cubic foot of area dedicated for the power station. The amount of water storage should be enough to assure consistent current and power through variable periods of wind strength. The power system could then be connected to an energy grid for the provision of useful energy.

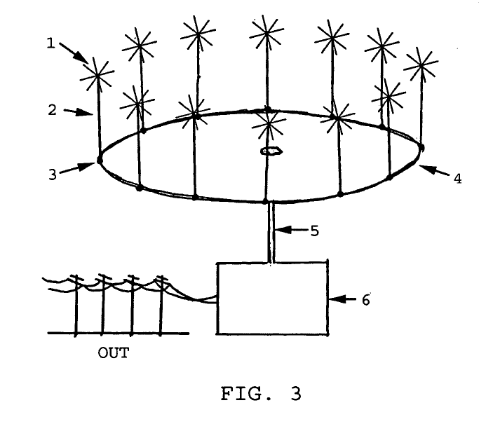

In reference to the invention configuration in FIG. 3, which shows what consists again of a surface in which the individual energy harnessers are individual propellers 1 that are shown connected through a shaft 2. The movement of each of the individual propellers is channeled through a mechanism to transmit 3 to the movement of a plate 4, thus causing it through this connection to turn. The harnessers are not attached to the plate and remain stationary, transferring instead the captured energy to the movement of the plate. The conventional approach would be to convey this through a gear system that transfers the individual rotational motions of individual harnessers to a single motion that connects through a shaft 5 to a single or few generators 6, that are connected for useful energy output.

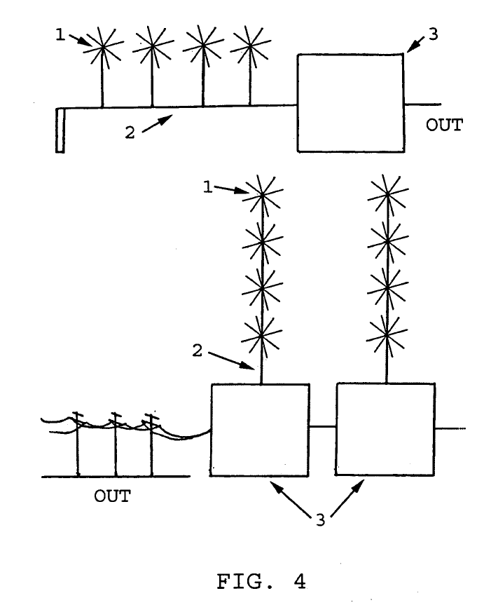

In reference to the invention configuration in FIG. 4 which shows what consists of individual energy harnessers that are individual propellers 1 that can be vertically or horizontally arranged, as shown, or in any other orientation. The movement of each of the individual propellers is channeled to the movement of a shaft 2, thus causing it through this connection to turn the shaft. The conventional approach would be to convey this through a gear or chain system that transfers the individual rotational motions of individual harnessers to a single motion that connects to a single or few generators 3, organized in a serial manner, as shown, or a parallel manner, that are connected to an output for useful energy output.

The invention improves the ability to produce harnessers that circumvent normal limitations with prior art conventional wind-energy generators. Since all of the harnessers are used to convey their energy to a single or a few electrical generators, this removes the need to build individual electrical generators for each harnesser, which is the current method used with wind-power generators. The current wind-power generator uses long blades to increase power, but the use of multiple harnessers permits an optimization to reduce visual pollution and increase efficiency that is not permissible with this prior art design. The use of individual harnessers linked through a fluid pumping system rather than an electrical system is preferred since it does not matter whether or not the individual propellers are in or out of phase. This permits increased efficiency since it is un-necessary to phase control the output and voltage of each of the many generators used to synchronize with the grid system being fed.

The harnessers of this invention do not have to be made large, nor do they have an electrical generator on each supporting tower, that use a few blades that are long and consequently create visually displeasing or distracting motion. The harnessers can be made much smaller than is allowed in the prior art, and, as the energy output does not fall as quickly as the volume is reduced, the cost can be reduced considerably with savings in material quantities until optimal cost to benefit ratio is achieved. (The smaller the propeller and pump, the greater the energy generated per pound of material. The reduced energy capacity is made up by increasing the number of propeller and pump units, so there is little limit to the range of sizes chosen for the harnesser.) The blades can also be made more numerous and thus run at a slower rate but a higher torque, permitting a greater range of possible materials to be used for construction of the blade, such as transparent materials. Thin transparent small size blades operating on a supporting pole or structure would not be as easily visible and would not be visible at all at larger distances. Or, many multiple but opaque blades packed close together on a single or many shafts could be used which would also be less visible since considerably less light is passed between the moving blades then in the prior art case. This permits the construction of the invention in regions where views are valued, and so the presence of such systems would not be objectionable, while it can still take advantage of an energy source that is renewable.

In this invention each harnesser conveys its energy to a single or a few electrical generators. Several methods could be used to convey the energy from the harnesser to the electrical generator, examples of which would be by hydraulic, electrical, or mechanical methods, or a combination of several forms. Using a turbine connected to an electrical generator, the energy conveyed from the harnessers will produce usable electrical energy. In each system one or more turbines receives the output from a multiplicity of harnessers and pump units. The total number of harnessers and pump combinations and the number of electrical generators can vary depending upon efficiency optimization and construction location, including requirements for the visibility requirements of the construction.

A proposed model for the invention could be used, for example, over a body of water, consisting of an array of wind harnessers connected to a turbine and electrical generator combination. Each wind harnesser would, for increased cost effectiveness and reduced resource requirements, be made as small as possible. To show this, by example, if a wind generating system is halved in size, the amount of energy produce is reduced by a factor of 4 since the area of the blade moved by the wind is reduced by a factor of 4, but the volume of material needed to construct each device is reduced by a factor of 8 since volume goes as the cube of the linear dimensions. So if 4 of the half size units are constructed to keep the total output constant, only half the total amount of material is used. The smaller the blades the less visual pollution occurs since the human eye can no longer perceived the motion of the blades at a distance. In addition, the blades and much of the supporting structure could be made of transparent materials that would not be easily visible.

The system of capturing the energy of the wind could also be used to supplement the conventional hydraulic system of generating electricity through falling water. During periods of high wind, the ability of the harnessers could be used to pump water that has already been used to generate electricity and is at a low level, back up a dam to the water holding area behind the dam and then used to generate additional electricity through the existing power generating system. The system can be added to any conventional hydro-electric system such as a dam that employs falling water, as an add-on. The wind driven harnessers can pump water from below the level of power generation back up to the higher water storage area, and then the conventional turbine and electrical generators already present in the unmodified system used to generate power.

Because of the nature of this system to both generate and store energy that can be used to generate electrical power, the chief objection to wind power has been eliminated. This is the cost of back-up equipment to generate power during periods when the wind velocity is insufficient to be used.

The harnessers would be able to incorporate other aspects such as the ability to swivel to ideally capture according to the most powerful direction of the wind. The specific design of the harnesser can take advantage of numerous inventions and designs already present in the art, such as blade design, structural design, and energy conveyance methods.

This simplified design permits reduced energy in manufacture, so that the total energy of construction is less than the energy returned through its lifetime. The system can run effectively with little maintenance because the design is so simple, which increases its lifetime and permits greater harnessing of energy for each initial construction of the invention.

What is claimed is:

1) An energy system by which energy is captured by a multiplicity of units, where the units do not contain their own individual electrical generators, that are in motion from an external compelling force.

2) The energy system of claim 1 where the multiplicity of units are in motion independently.

3) The energy system of claim 1 where the multiplicity of units are linked to an energy conveyance system.

4) The energy system of claim 3 where the energy conveyance system is linked to an energy storage device.

5) The energy system of claim 3 where the energy conveyance system is linked to an electrical generation system.

6) The energy system of claim 3 where the energy conveyance system is linked to an electrical generation system and an energy storage device.

7) The energy system of claim 5 where the electrical generation system is one or more rotational generators.

8) The energy system of claim 7 where the rotational generators are linked electrically to the rotational generators of other energy systems.

9) The energy system of claim 3 where the method of energy conveyance is a fluid that is pumped.

10) The energy system of claim 9 where the energy conveyance system is linked to an energy storage device.

11) The energy system of claim 9 where the energy conveyance system is linked to an electrical generation system.

12) The energy system of claim 9 where the energy conveyance system is linked to an electrical generation system and an energy storage device.

13) The energy system of claim 11 where the electrical generation system is one or more rotational generators.

14) The energy system of claim 13 where the rotational generators are linked electrically to the rotational generators of other energy systems.

15) The energy system of claim 3 where the method of energy conveyance is the mechanical motion of a shaft.

16) The energy system of claim 15 where the energy conveyance system is linked to an energy storage device.

17) The energy system of claim 15 where the energy conveyance system is linked to an electrical generation system.

18) The energy system of claim 15 where the energy conveyance system is linked to an electrical generation system and an energy storage device.

19) The energy system of claim 17 where the electrical generation system is one or more rotational generators.

20) The energy system of claim 19 where the rotational generators are linked electrically to the rotational generators of other energy systems.
